(19) United States
(12) Patent Application Publication
(10) Pub. No.: US 2026/0354360 A1
(43) Pub. Date: Nov. 12, 2026

(54) Noise-Producing Fishing Lure with Magnetically Actuated Rattle

(71) Applicant: Strike King Lure Company, LLC, Columbia, SC (US)

(72) Inventor: Shane Fetty, Columbia, SC (US)

(73) Assignee: Strike King Lure Company, LLC, Columbia, SC (US)

(21) Appl. No.: 19/202,129

(22) Filed: May 8, 2025

(51) Int. Cl. A01K 85/01; A01K 85/10; H01F 7/02

(52) U.S. Cl. CPC A01K 85/017; A01K 85/10; H01F 7/0273

(57) ABSTRACT

A fishing lure having a housing combined with a connecting member. The housing has a chamber disposed within it that contains a rattle. The rattle has a magnetic field and is free to move within the chamber. The fishing lure also comprises a rotating member which is disposed around the connecting member such that the rotating member is freely rotatable. The rotating member comprises a fin containing a ferrous material that can interact with the rattle. As the lure moves through the water, the fin causes the rotating member to rotate. Because the rattle is freely movable within the chamber, as the fin rotates, its interaction with the magnetic field causes the rattle to be drawn toward the fin, within the chamber, resulting in contact with a side of the chamber. This contact with a side of the chamber produces a rattling noise.

### BACKGROUND

There is a wide variety of fishing tackle on the market today. Selection of tackle generally depends on the preferences of the angler, the species of fish sought, lighting, water conditions, season, availability, fishing style, and other factors. Tackle is often designed to have a feature that may mimic the natural prey of the fish that an angler is targeting or to have a characteristic that grabs the attention of the fish. This may include general shape and size, vibration and sound, color and reflective or glowing surfaces, movement of the lure, and even scent or flavor.

Fishing lures that make rattling sounds (also referred to as clacking, clicking, knocking, and the like) are one category of fishing tackle that are commonly used to produce strikes. These lures generally contain small beads or other components within a chamber that contact each other or the sides of the chamber as the lure moves through the water. Rattles may be fixed internally or externally to the housing of the fishing lure. Often, the rattle sound results from a side-to-side motion of the lure or flexing of the lure at a pivoting joint. This occurs at random as the lure is bounced around during its descent in the water, as it is carried in a current, as it is pulled through the water by the angler, or while it is retrieved from the water by the angler.

Because this motion is random, it is difficult to ensure the rattling noise is consistently occurring the beads or other components remain in consistent motion within the chamber. The space available for the rattling mechanism is small, due to the nature of fishing lures; this limits the noise producing capabilities. The speed at which the lure moves can have a significant effect on whether the rattle sound is produced consistently or at all. Additionally, environmental conditions, such as if the lure catches a piece of debris, can prevent the lure from rattling. There is therefore a need for an improved fishing lure that can more consistently and predictably produce a rattling sound as it moves through the water.

### SUMMARY

One aspect of the disclosure includes a fishing lure having a housing fixed to a connecting member. The housing has a chamber disposed within it that contains a rattle, which is free to move within the chamber. The fishing lure also comprises a rotating member which is disposed around the connecting member. The rotating member is freely rotatable in relation to the housing and has a fin that extends radially from it. As the lure moves through the water, water pressure on the fin causes the rotating member to rotate. At least one of the rattle and rotating member comprises a magnetic material, and the other may either comprise a magnetic or ferrous material, such that the rattle and the rotating member interact through a magnetic field. Because the rattle is freely movable within the chamber, as the fin rotates, the magnetic interaction causes the rattle to contact a first side of the chamber. This contact with a side of the chamber produces a noise. In some forms, as the rotating member continues to rotate, the magnetic interaction causes the rattle to contact a second side of the chamber. In some forms, as the rotating member continues to rotate, the rotating member exits the magnetic field, which leaves the rattle free within the chamber.

Another aspect of the disclosure includes a fishing lure having a housing fixed to a connecting member, which is formed as an elongated shaft, and an auxiliary end fixed to the connecting member. The fishing lure further has a rotating member that at least partially surrounds the connecting member, such that the rotating member can freely rotate around the connecting member. The rotating member has a fin. The housing of the fishing lure further comprises a chamber, which holds a rattle, and the chamber is configured such that the rattle can move from a first side of the chamber to a second side of the chamber. At least one of the rattle and fin is comprised of a magnetic material, and the other may either be comprised of a magnetic or ferrous material, such that the rattle and the fin have a magnetic interaction. As the fin rotates, the magnetic interaction causes the rattle to contact a side of the chamber. Contact with a side of the chamber produces a noise. In some forms, as the rotating member continues to rotates, the magnetic field continues to interact with the rattle and causes the rattle to contact a second side of the chamber. In some forms, as the rotating member continues to rotate, the fin severs the magnetic interaction, which leaves the rattle free within the chamber.

Another aspect of the invention includes a lure which has a housing fixed to a connecting member and an auxiliary end fixed to a connecting member. The lure has a chamber within the housing of the lure, which is configured to receive a rattle having a magnetic field such that the rattle can move from one side of the chamber to the other, in a horizontal bi-directional manner, perpendicular to the longitudinal axis of the connecting member. The lure also has a rotating member which is disposed about the connecting member and configured to be freely rotatable around the connecting member. The rotating member also has a ferrous component which interacts with the magnetic field. As the rotating member rotates, the interaction of the ferrous component and the magnetic field causes the rattle to contact a first side of the chamber and then, as the rotating member continues to rotate, a second side of the chamber. This contact with a side of the chamber produces a noise. In some forms, as the rotating member continues to rotate, the ferrous component severs its interaction with the magnetic field, which leaves the rattle free within the chamber. In some forms, the ferrous component is a fin extending axially from the connecting member.

Yet another aspect of the invention includes a method of fishing using a lure. The method includes providing a lure that has a housing, a connecting member, an auxiliary end, and a rotating member. The housing is fixed to the connecting member and the auxiliary end is fixed to the connecting member. The housing also includes a chamber configured to hold a rattle that is freely movable within the chamber. The rotating member is disposed around the connecting member such that it is freely rotatable. The rotating member also contains a fin, which contains a ferrous material. The method further includes securing the lure to a fishing line and casting the lure into water. While in the water, water resistance pushes against the fin, causing the rotating member to rotate about the connecting member. This then causes the ferrous material of the fin to interact with the magnetic field such that the rattle contacts a first side of the chamber and then a second side of the chamber. This contact with a side of the chamber produces a noise.

### BRIEF DESCRIPTION OF THE DRAWINGS

FIG. 1 is a side view of an embodiment of the noise-producing lure.

FIG. 2 is a partial cross-section side view of an embodiment of the noise-producing lure.

FIG. 3 is a partial cross-section perspective view of an embodiment of the noise-producing lure.

FIG. 4 is a partial cross-section top view of an embodiment of the noise-producing lure.

### DETAILED DESCRIPTION

FIG. 1 is a side view of an embodiment of the noise-producing lure according to the present invention. In an embodiment, the lure 10 includes a housing 12, a connecting member 22, and an auxiliary end 24. The housing 12, the connecting member 22 and the auxiliary end 24 may be integrally formed or may be manufactured separately and then assembled. In an embodiment, the connecting member 22 is formed as an elongated shaft. The lure 10 also includes a rotating member 14, that is disposed around the connecting member 22. Rotating member 14 is freely rotatable around connecting member 22 relative to the housing 12. In an embodiment, the rotating member 14 comprises either a ferrous or magnetic component. In an embodiment, this ferrous or magnetic component is a fin 16.

A fin 16 protrudes from rotating member 14 in a generally axial manner. The fin 16 has a leading edge and a spaced trailing edge with a surface extended therebetween configured to engage water. The fin 16 is shaped such that as the lure 10 moves through water, the water resistance pressing against the surface of the fin 16 causes the rotating member 14 to rotate about the connecting member 22. Rotation may occur as the lure 10 descends into the water, as it is carried in a current, as it is pulled through the water by the angler, or while it is retrieved from the water by the angler.

In some embodiments, the surface of the fin 16 that engages the water may have a generally concave shape. In some embodiments, the surface of the fin 16 which engages the water is shaped in a spiral plane. In an embodiment, the fin 16 may be shaped like a propeller. In some embodiments, the surface of the fin 16 that engages the water may be substantially straight. These shape descriptions for the fin 16 are exemplary; other shapes may be used. The shape of the fin 16 may be adjusted to vary the speed of rotation desired. The fin 16 may be shaped such that the rotating member 14 rotates in a clockwise or counter-clockwise direction relative to the housing 12. In an embodiment, the fin 16 is composed at least partially of a ferrous material. In an embodiment, the fin 16 is composed at least partially of a magnetic material.

In an embodiment, treble hooks 18 are provided, which connect to the housing 12 and the auxiliary end 24 such that when a fish strikes the lure, the fish can be retrieved by the angler.

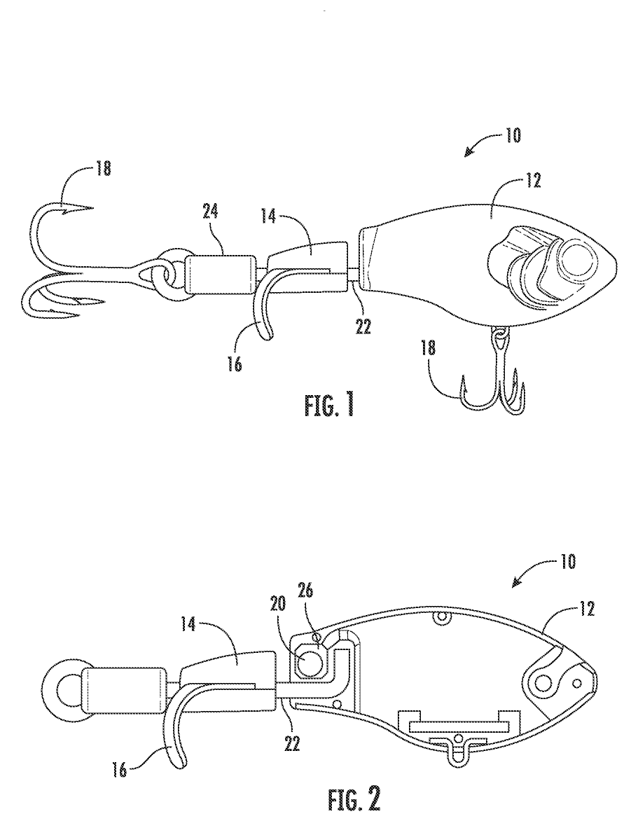

FIG. 2 shows a partial cross-sectional side view of the housing 12 of an embodiment of the lure 10. The housing 12 has a chamber 26 therein, which is configured to contain a rattle 20. In an embodiment, the rattle 20 is composed at least partially of a magnetic material for producing a magnetic field. In an alternate embodiment, the rattle 20 is composed at least partially of a ferrous material. In an embodiment, the rattle 20 is spherical.

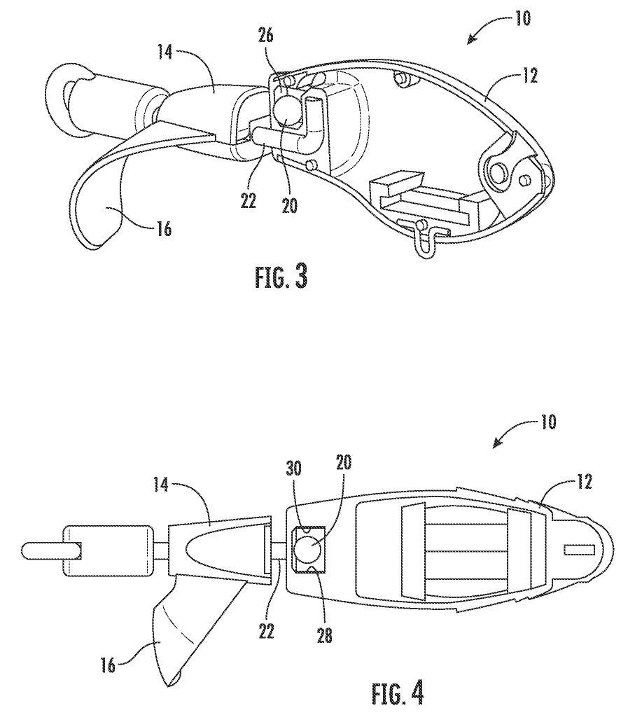

As can be seen in combination with FIGS. 3 and 4, the chamber 26 is sized such that the rattle 20 is freely movable therein. In other words, in some embodiments the chamber 26 has a volume that is greater than the size of the rattle 20 with respect to the chamber’s length, width, and height. FIG. 4 shows an embodiment wherein the rattle 20 is within the chamber 26, such that the rattle’s primary movement is between a first side 28 of the chamber 26 and a second side 30 of the chamber 26 due to the chamber 26 having a width (side-to-side relative to the longitudinal axis of the lure 10) that is longer than the length (front-to back). In an embodiment, the magnetic interaction between the fin 16 and the rattle 20 dictates this side-to-side movement. In some embodiments the chamber 26 may be sized such that the rattle 20 primarily moves in a bi-directional horizontal (side-to-side) manner, perpendicular to the longitudinal axis of the connecting member 22. In some embodiments, the chamber may be substantially tube-shaped. The length of the chamber 26 corresponding to the distance the rattle 20 travels may vary based on the size and shape of the lure 10, as well as the nature of the magnetic field causing the rattle 20 to move. Different lengths will result in different noise levels and cadences for the rattling sound.

As discussed above, water resistance pressing against a surface of the fin 16 causes the rotating member 14 to rotate around a central longitudinal axis through a plurality of different positions. In an embodiment, the magnetic field produced by the rattle 20 interacts with the ferrous material of the fin 16, such that the rattle 20 is attracted to the fin 16 and therefore the rattle 20 is pulled toward the fin 16 while remaining within the chamber 26. In an embodiment, the magnetic field produced by the fin 16 interacts with the ferrous material of the rattle 20, such that the rattle 20 is attracted to the fin 16 and therefore the rattle 20 is pulled toward the fin 16 while remaining within the chamber 26. In an embodiment, the magnetic field of the rattle 20 interacts with the magnetic field of the fin 16, such that the interaction of the two magnetic fields causes the rattle 20 to move within the chamber 26.

In an embodiment, the lure 10 is configured such that as the rotating member 14 rotates to a first position the magnetic interaction between the fin 16 and the rattle 20 causes the rattle 20 to contact a first side 28 of the chamber 26. In an embodiment, as the rotating member 14 rotates to a second position, the magnetic interaction between the fin 16 and the rattle 20 causes the rattle 20 to contact a second side 30 or the chamber 26. In an embodiment, as the rotating member 14 rotates to a third position, the magnetic interaction between the fin 16 and the rattle 20 is severed. In an embodiment, as the rotating member 14 rotates to a fourth position, the magnetic interaction between the fin 16 and the rattle 20 is severed. In an embodiment, a cycle is formed, wherein the rotating member 14 moves from the first position, to the second position, and this order continues to repeat. This cycle produces multiple noises as the rattle 20 actuates between the first side 28 and the second side 30 of the chamber 26, such that a consistent rattling noise is produced. In an embodiment, a cycle is formed, wherein the rotating member 14 moves from the first position, to the second position, to the third position, and this order continues to repeat. This cycle produces multiple noises as the rattle 20 actuates between the first side 28 and the second side 30 of the chamber 26, such that a consistent rattling noise is produced. In an embodiment, a cycle is formed wherein the rotating member 14 moves from the first position, to the fourth position, to the second position, to the third position, and this order continues to repeat. This cycle produces multiple noises as the rattle 20 actuates between the first side 28 and the second side 30 of the chamber 26, such that a consistent rattling noise is produced.

In an embodiment, the lure 10 is configured such that as the rotating member 14 rotates to a first position, the ferrous fin 16 interacts with the magnetic field of the rattle 20 causing the rattle 20 to contact a first side 28 of the chamber 26. In an embodiment, as the rotating member 14 rotates to a second position, the ferrous fin 16 interacts with the magnetic field of the rattle 20 causing the rattle 20 to contact a second side 30 or the chamber 26. In an embodiment, as the rotating member 14 rotates to a third position, the ferrous fin 16 exits the magnetic field. In an embodiment, as the rotating member 14 rotates to a fourth position, the ferrous fin 16 exits the magnetic field. In an embodiment, a cycle is formed, wherein the rotating member 14 moves from the first position, to the second position, and this order continues to repeat. This cycle produces multiple noises as the rattle 20 actuates between the first side 28 and the second side 30 of the chamber 26, such that a consistent rattling noise is produced. In an embodiment, a cycle is formed, wherein the rotating member moves from the first position, to the second position, to the third position, and this order continues to repeat. This cycle produces multiple noises as the rattle 20 actuates between the first side 28 and the second side 30 of the chamber 26, such that a consistent rattling noise is produced. In an embodiment, a cycle is formed wherein the rotating member moves from the first position, to the fourth position, to the second position, to the third position, and this order continues to repeat. This cycle produces multiple noises as the rattle 20 actuates between the first side 28 and the second side 30 of the chamber 26, such that a consistent rattling noise is produced.

In an embodiment, to prevent interference with the desired movement of the rattle, the housing 12, connecting member 22, auxiliary end 24, and chamber 26 of the lure are comprised of non-magnetically attractive materials.

In an embodiment, the lure generally takes the form of a bait fish. In an embodiment, the housing resembles the head of a bait fish and the auxiliary end resembles the tail of a bait fish.

In an embodiment, the fishing lure is connected to a fishing line and cast into water by an angler as is known in the art. As the lure moves through the water, it creates a rattling noise through the movement of the rattle as described in previous embodiments.

Having thus described the invention in connection with the above embodiments, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is:

1. A fishing lure, comprising:
a housing with a chamber therein having a first side wall and a second side wall;
a rattle positioned within the chamber;
wherein the rattle is freely movable with in the chamber;
a rotating member attached to the housing with a connecting member, wherein the rotating member is freely rotatable relative to the housing and wherein the rotating member has a fin configured to engage the water to rotate the rotating member when the fishing lure is moving through water;
wherein one of the rattle and a portion of the rotating member comprise a magnetic material providing a magnetic field and the other of the rattle and the portion of the rotating member comprises a magnetic or ferrous material;
wherein as the rotating member rotates to a first position, the magnetic field interacts with the ferrous material causing the rattle to move toward and contact the first side of the chamber.

2. The fishing lure of claim 1, wherein as the rotating member rotates to a second position, the magnetic field causes the rattle to move toward and contact the second side of the chamber.

3. The fishing lure of claim 1, wherein as the rotating member rotates to a third position, the ferrous material exits the magnetic field.

4. The fishing lure of claim 2, wherein as the rotating member rotates to a fourth position, the ferrous material exits the magnetic field.

5. The fishing lure of claim 1, wherein the fin is configured to engage the water causing the rotating member to rotate.

6. The fishing lure of claim 1, wherein a surface of the fin configured to engage the water has a concave shape.

7. The fishing lure of claim 1, further comprising a first treble hook connected to the housing and a second treble hook connected to an auxiliary end, wherein the auxiliary end is attached to the connecting member.

8. The fishing lure of claim 1, wherein the rattle comprises the magnetic material and the portion of the rotating member comprises the ferrous material.

9. The fishing lure of claim 8, wherein the portion of the rotating member comprising the ferrous material is the fin.

10. A fishing lure, comprising:
a housing fixed to a connecting member and an auxiliary end fixed to the connecting member, wherein the connecting member is an elongated shaft;
a rotating member which at least partially surrounds the connecting member, wherein the rotating member is freely rotatable around the connecting member;
wherein the rotating member comprises a ferrous fin;
a chamber within the housing configured to contain a rattle such that the rattle is free to move from a first side of the chamber to a second side of the chamber;
wherein the rattle and the ferrous fin have a magnetic attraction;
wherein as the ferrous fin rotates to a first position, the magnetic attraction causes the rattle to contact the first side of the chamber.

11. The fishing lure of claim 10, wherein as the ferrous fin rotates to a second position, the magnetic attraction causes the rattle to contact the second side of the chamber.

12. The fishing lure of claim 10, wherein as the ferrous fin rotates to a third position, the magnetic attraction is severed.

13. The fishing lure of claim 11, wherein as the ferrous fin rotates to a fourth position, the magnetic attraction is severed.

14. The fishing lure of claim 10, wherein water resistance causes the ferrous fin to rotate.

15. The fishing lure of claim 10, wherein a surface of the ferrous fin configured to engage the water has a concave shape.

16. The fishing lure of claim 10, further comprising a first treble hook connected to the housing and a second treble hook connected to the auxiliary end.

17. A lure, comprising:
a housing fixed to a connecting member and an auxiliary end fixed to the connecting member;
a chamber within the housing, configured to receive a rattle comprising a magnetic field, wherein the rattle is free to move horizontally between a first side of the chamber and a second side of the chamber;
a rotating member disposed about the connecting member and configured to be freely rotatable about the connecting member, wherein the rotating member comprises a ferrous component;
wherein the ferrous component interacts with the magnetic field, such that as the rotating member rotates to a first position, the rattle contacts the first side of the chamber and as the rotating member rotates to a second position, the rattle contacts the second side of the chamber.

18. The fishing lure of claim 17, wherein as the rotating member continues to rotate, the ferrous component severs its interaction with the magnetic field.

19. The fishing lure of claim 17, wherein the ferrous component is a fin extending from the rotating member.

20. The fishing lure of claim 19, wherein water resistance causes the fin to rotate.

21. A method of fishing, comprising:
providing a lure comprising a housing, a connecting member, and an auxiliary end, wherein the housing is fixed to the connecting member and the auxiliary end is fixed to the connecting member, a chamber within the housing configured to contain a rattle comprising a magnetic field, wherein the rattle is freely movable within the chamber, a rotating member disposed around the connecting member, wherein the rotating member is freely rotatable around the connecting member and wherein the rotating member has a fin comprised of a ferrous material;
securing the lure to a fishing line;
casting the lure into water, wherein water resistance pushes against the fin, causing the rotating member to rotate about the connecting member, such that the ferrous material interacts with the magnetic field causing the rattle to contact a first side of the chamber and a second side of the chamber.
